(19) United States
(12) Patent Application Publication
(10) Pub. No.: US 2014/0308371 A1
(43) Pub. Date: Oct. 16, 2014

(54) Acid Tablet Composition

(71) Applicant: Axiall Ohio, Inc., Atlanta, GA (US)

(72) Inventors: Claire R. F. Parasida, Cranberry Township, PA (US); Richard H. Ferguson, Cecil, PA (US)

(73) Assignee: Axiall Ohio, Inc., Atlanta, GA (US)

(21) Appl. No.: 14/217,595

(22) Filed: Mar. 18, 2014

Related U.S. Application Data
(60) Provisional application No. 61/810,391, filed on Apr. 10, 2013.

(51) Int. Cl. A01N 59/08; A01N 59/02

(52) U.S. Cl. CPC A01N 59/08; A01N 59/02
USPC 424/680

(57) ABSTRACT

A composition is described that includes: (a) at least one alkali metal hydrogen sulfate anhydrous, such as sodium hydrogen sulfate anhydrous; (b) at least one salt, that is different than the alkali metal hydrogen sulfate anhydrous, which is selected from alkali metal salt and/or alkaline earth metal salt, such as sodium chloride and/or magnesium sulfate; and (c) optionally a colorant, in which the composition is in the form of a tablet. There is also described a method of forming a treated aqueous stream using the tablet composition. There is further described a method of forming a treated sanitizing aqueous stream that involves combining the treated aqueous stream with a feed sanitizing aqueous stream. In addition, there is described a method of sanitizing a surface that involves applying the treated sanitizing aqueous stream to a surface to be treated, such as animal carcass surfaces.

### CROSS REFERENCE TO RELATED APPLICATION

The present application is entitled to and claims priority to U.S. Provisional Patent Application No. 61/810,391, filed on Apr. 10, 2013, the disclosure of which is incorporated herein by reference in its entirety.

### FIELD OF THE INVENTION

The present invention relates to a composition that includes at least one alkali metal hydrogen sulfate anhydrous, at least one salt that is different than the alkali metal hydrogen sulfate anhydrous, in which the salt is selected from alkali metal salt and/or alkaline earth metal salt, and optionally a colorant, in which the composition is in the form of a tablet, and to methods of treating an aqueous stream with such a composition.

### BACKGROUND OF THE INVENTION

Modifying the pH of a water source, such as a water source that includes a source of free available halogen, can be desirable in certain applications, such as the cleaning and/or sanitizing of food and/or equipment surfaces by application of the water source thereto. In some applications it is desirable to reduce the pH of the water source, such as to less than 7. Reducing the pH of a water source can serve to reduce the alkalinity of the water, such as alkalinity due to aqueous bicarbonate, which if not reduced can result in the undesirable formation of scale, such as calcium carbonate scale, on surfaces that come into contact with the water. Reducing the pH of a water source that includes free available halogen, such as free available chlorine, can serve to desirably enhance the sanitizing properties of the free available halogen and correspondingly reduce or minimize the occurrence of undesirable microbes, such as bacteria, yeasts, and/or molds, within the water source itself and/or on surfaces to which it is applied. In some applications, it is desirable to controllably modify the pH of the water source, such that it has a pH value residing within a predetermined range. If the pH of the water source is outside of the predetermined range, the cleansing and/or sanitizing properties of the water source may be undesirably reduced.

With some applications, the pH of a water source can be reduced by the addition of a liquid acid, such as hydrochloric acid (HCl) or aqueous solutions of citric acid, thereto. Controllably introducing a liquid acid to the water source can be difficult in some instances, resulting in pH values that reside outside of a predetermined range. In addition, storage of the liquid acid can raise issues relating to safety and environmental impact, and related increased costs, such as increased costs associated with providing secondary containment of the liquid acid if storage containers containing the liquid acid are breached. Handling of the liquid acid (e.g., HCl) can raise safety and corrosion issues, such as exposure of workers and equipment to the liquid acid or its vapors.

It would be desirable to develop new compositions and methods that can be used to modify the pH of a water source. It would be further desirable that such newly developed compositions and methods provide for the controllable modification of the pH of a water source. It would be additionally desirable that such newly developed compositions and methods have associated therewith safety issues and environmental impacts that are no greater than and preferably less than those associated with previous methods of modifying the pH of a water source.

### SUMMARY OF THE INVENTION

In accordance with the present invention, there is provided a composition comprising: (a) at least one alkali metal hydrogen sulfate anhydrous; (b) at least one salt that is different than the alkali metal hydrogen sulfate anhydrous, wherein the salt is selected from the group consisting of alkali metal salt, alkaline earth metal salt, and combinations thereof; and (c) optionally a colorant, in which the composition is in the form of a tablet.

In further accordance with the present invention, there is provided a method of forming a treated aqueous stream comprising: (a) providing the tablet composition as described above; and (b) contacting a feed aqueous stream with the tablet composition, thereby forming the treated aqueous stream. There is also provided, in accordance with the present invention, a treated water source that has been prepared in accordance with one or more methods of the present invention.

In accordance with the present invention, there is further provided a method of forming a treated sanitizing aqueous stream comprising: (a) providing the tablet composition as described above; (b) contacting a first feed aqueous stream with the tablet composition, thereby forming a first treated aqueous stream; and (c) combining at least a portion of the first treated aqueous stream with a feed sanitizing aqueous stream comprising free available halogen, thereby forming the treated sanitizing aqueous stream comprising free available halogen.

In accordance with the present invention, there is additionally provided a method of sanitizing a surface comprising: (a) providing the tablet composition as described above; (b) contacting a first feed aqueous stream with the tablet composition, thereby forming a first treated aqueous stream; (c) combining at least a portion of the first treated aqueous stream with a feed sanitizing aqueous stream comprising free available halogen, thereby forming a treated sanitizing aqueous stream comprising free available halogen; and (d) applying the treated sanitizing aqueous stream to a surface to be sanitized.

The features that characterize the present invention are pointed out with particularity in the claims, which are annexed to and form a part of this disclosure. These and other features of the invention, its operating advantages and the specific objects obtained by its use will be more fully understood from the following detailed description in which non-limiting embodiments of the invention are illustrated and described.

### BRIEF DESCRIPTION OF THE DRAWINGS

FIG. 1 is a schematic representation of a water treatment system that can be used with a method according to the present invention;

FIG. 2 is a schematic representation of another water treatment system that can be used with a method according to the present invention; and

FIG. 3 is a schematic representation of a further water treatment system that can be used with a method according to the present invention.

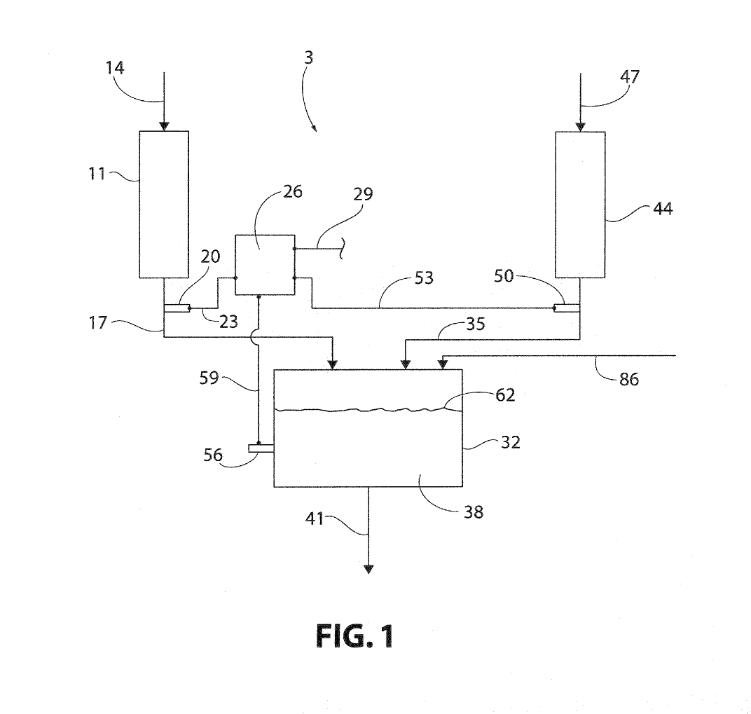

In FIGS. 1 through 3, which are not to scale, like reference characters designate the same components and structural features.

### DETAILED DESCRIPTION OF THE INVENTION

As used herein, spatial or directional terms, such as “left”, “right”, “inner”, “outer”, “above”, “below”, and the like, relate to the invention as it is shown in the drawing figures. However, it is to be understood that the invention can assume various alternative orientations and, accordingly, such terms are not to be considered as limiting.

Other than in the operating examples, or where otherwise indicated, all numbers expressing quantities of ingredients, reaction conditions, processing parameters, physical characteristics, dimensions, and the like used in the specification and claims are to be under stood as modified in all instances by the term “about.”

Unless otherwise indicated, all ranges or ratios disclosed herein are to be understood to encompass any and all subranges or subratios subsumed therein. For purposes of non-limiting illustration, a stated range or ratio of “1 to 10” should be considered to include any and all subranges between (and inclusive of) the minimum value of 1 and the maximum value of 10; that is, all subranges or subratios beginning with a minimum value of 1 or more and ending with a maximum value of 10 or less, such as but not limited to, 1 to 3.3, 4.7 to 7.5, 5.5 to 10, and the like.

As used herein, the articles “a,” “an,” and “the” include plural referents unless otherwise expressly and unequivocally limited to one referent.

All documents, such as but not limited to issued patents and patent applications, referred to herein, and unless otherwise indicated, are to be considered to be “incorporated by reference” in their entirety.

The compositions of the present invention are in the form of a tablet. As used herein, the term “tablet” means a three-dimensionally shaped object that is composed of the composition of the present invention and which is self supporting.

The composition of the present invention, in accordance with some embodiments, is referred to herein as a “tablet composition” or a “tablet(s).”

With some embodiments, the tablets of the present invention have any desirable shape and dimension. The tablets of the present invention have, with some further embodiments, a disk-like shape with: a height of from 15 to 50 mm, or from 20 to 40 mm, or from 22 to 35 mm, such as 28 mm; and a diameter of from 3 to 10 cm, or from 4 to 8 cm, or from 5 to 7 cm, such as 6.7 cm.

The tablets of the present invention, with some embodiments, have a density of from 1.8 to 2.2 g/cm³, or from 1.80 to 2.20 g/cm³, or from 2.0 to 2.1 g/cm³, or from 2.00 to 2.10 g/cm³, or from 2.01 to 2.08 g/cm³, or from 2.02 to 2.05 g/cm³.

The tablets of the present invention have, with some embodiments, a moisture absorption of less than 10 percent by weight, such as from 1 to 10 percent by weight, or from 2 to 9 percent by weight, or from 5 to 8.5 percent by weight, based on the initial weight of the tablet (such as prior to exposure to moisture). The moisture absorption is determined, with some embodiments, by suspending a tablet at room temperature (such as 25° C.) above water in a closed container for 200 hours. The tablet is weighed periodically, such as daily, during the course of the test, and the weight of the tablet is compared to that of the tablet prior to being placed in the container, and the percent weight of water absorption is calculated from such comparison. In accordance with some embodiments, the tablets of the present invention have a moisture absorption of from 5 to 8.5 percent by weight, such as 8.1 percent by weight, and are substantially free of crumbling, as determined by subjecting the tablet to torsional and flexural stresses by human hands.

The tablets of the present invention can be formed, with some embodiments, by mixing (such as dry mixing) together the components thereof, such as the alkali metal hydrogen sulfate anhydrous (a), salt (b), and optional colorant (c), to form a substantially homogenous composition. The substantially homogenous composition is, with some embodiments, placed in a mold, such as a metal mold, such as a stainless steel mold, and subjected to elevated pressure for a period of time. The elevated pressure can, with some embodiments, be at least 10,000 pounds per square inch (psi), such as from 10,000 to 30,000 psi, or from 15,000 to 25,000 psi, such as, 22,000 psi. The tablet mold is opened, and the tablet according to the present invention is removed therefrom.

The compositions of the present invention include at least one alkali metal hydrogen sulfate anhydrous. As used herein, the terms “alkali metal hydrogen sulfate anhydrous,” “anhydrous alkali metal hydrogen sulfate,” “alkali metal bisulfate anhydrous,” and “anhydrous alkali metal bisulfate” are equivalent terms.

The alkali metal hydrogen sulfate anhydrous material can be in any suitable form. With some embodiments, the alkali metal hydrogen sulfate anhydrous material is in the form of a solid particulate material. In accordance with some further embodiments, the alkali metal hydrogen sulfate anhydrous material is in the form of a solid particulate material having an average particle size of from 25 microns to 1000 microns, or 50 microns to 1000 microns, or 100 microns to 1000 microns, or 150 microns to 1000 microns, or 200 microns to 1000 microns, or from 250 microns to 800 microns, or from 300 microns to 700 microns, or from 400 microns to 600 microns.

The alkali metal of the alkali metal hydrogen sulfate anhydrous is, with some embodiments, selected from any suitable alkali metal, such as, but not limited to, lithium, sodium, and potassium. In accordance with some embodiments, the alkali metal of the alkali metal hydrogen sulfate anhydrous is selected from sodium and potassium. The alkali metal hydrogen sulfate anhydrous is, with some further embodiments, selected from sodium hydrogen sulfate anhydrous, potassium hydrogen sulfate anhydrous, and combinations thereof. With some further embodiments, the alkali metal hydrogen sulfate anhydrous is sodium hydrogen sulfate anhydrous.

The alkali metal hydrogen sulfate anhydrous, with some embodiments, contains water in an amount of 0 percent by weight to 1 percent by weight, or from 0 percent by weight to 0.5 percent by weight, or from 0 percent by weight to 0.2 percent by weight, or from 0 percent by weight to 0.1 percent by weight, the percent weights being based on the weight of the alkali metal hydrogen sulfate anhydrous.

In accordance with some embodiments, the alkali metal hydrogen sulfate anhydrous is present in the composition in an amount of about 50 percent by weight to about 99 percent by weight, or about 75 percent by weight to about 98 percent by weight, or about 80 percent by weight to 95 percent by weight, or about 88 percent by weight to about 92 percent by weight, or about 88.5 percent by weight to about 91.5 percent by weight, or about 89 percent by weight to about 91 percent by weight, the percent weights being based on total weight of the composition.

The alkali metal salt of the salt (b) of the compositions of the present invention is, with some embodiments, selected from one or more alkali metal halides, one or more alkali metal sulfates, and combinations thereof. The alkaline earth metal salt of the salt (b) of the compositions of the present invention is, with some embodiments, selected from one or more alkaline earth metal sulfates.

The alkali metal of each alkali metal salt of the salt (b) of the compositions of the present invention is, with some embodiments, independently selected from sodium and potassium.

The alkali metal of each alkali metal halide of the salt (b) of the compositions of the present invention is, with some embodiments, independently selected from sodium and potassium. In accordance with some additional embodiments, the halide of each alkali metal halide of the salt (b) of the compositions of the present invention is independently selected from fluoride, chloride, bromide, and iodide.

The salt (b) of the compositions of the present invention is selected from one or more alkali metal halides, such as, but not limited to, sodium chloride, potassium chloride, and combinations thereof, with some embodiments. In accordance with some further embodiments, the salt (b) is sodium chloride.

With some embodiments, the alkali metal sulfate of the salt (b) of the compositions of the present invention is selected from sodium sulfate, potassium sulfate, and combinations thereof. The salt (b) of the compositions of the present invention is selected from one or more alkali metal sulfates, such as sodium sulfate and/or potassium sulfate, with some embodiments. In accordance with some further embodiments, the salt (b) is sodium sulfate.

The alkaline earth metal of the alkaline earth metal salts of salt (b) of the compositions of the present invention are, with some embodiments, in each case independently selected from magnesium, calcium, and barium. The alkaline earth metal salts of salt (b) are, with some embodiments, selected from one or more alkaline earth metal sulfates, such as magnesium sulfate, calcium sulfate, barium sulfate, and combinations of two or more thereof.

In accordance with some embodiments, the salt (b) of the compositions of the present invention is selected from one or more alkaline earth metal sulfates, such as magnesium sulfate, calcium sulfate, barium sulfate, and combinations of two or more thereof. In accordance with some embodiments, the salt (b) is magnesium sulfate.

In accordance with some embodiments, the salt (b) of the compositions of the present invention is present in an amount of about 1 percent by weight to about 50 percent by weight, or about 2 percent by weight to about 25 percent by weight, or about 5 percent by weight to about 20 percent by weight, or about 8 percent by weight to about 12 percent by weight, or about 8.5 percent by weight to about 11.5 percent by weight, or about 9 percent by weight to about 11 percent by weight, the percent weights being based on total weight of said composition.

With some embodiments of the compositions of the present invention, the alkali metal hydrogen sulfate anhydrous (a) is sodium hydrogen sulfate anhydrous, and the salt (b) is sodium chloride.

The salt (b) of the compositions of the present invention, with some embodiments, is free of halide, such as halide anion. In accordance with some embodiments, the salt (b) is free of fluoride, chloride, bromide, and iodide, such as fluoride anion, chloride anion, bromide anion, and iodide anion. With some further embodiments, the salt (b) of the compositions of the present invention is free of one or more alkali metal halides, and is free of one or more alkaline earth metal halides.

The compositions of the present invention further include, with some embodiments, one or more colorants. Each colorant can, with some embodiments, be independently selected from one or more dyes, one or more pigments, and combinations thereof. Examples of dyes from which the colorant can be selected, with some embodiments, include, but are not limited to, dyes having the following US Food and Drug Administration designations: FD&C Blue No. 1, FD&C Blue No. 2, FD&C Green No. 3, FD&C Red No. 40, FD&C Red No. 3, FD&C Yellow No. 5, FD&C Yellow No. 6, and combinations of two or more thereof. Examples of pigments from which the colorant can be selected, with some embodiments, include, but are not limited to, inorganic pigments, organic pigments, and combinations thereof. Examples of inorganic pigments include, but are not limited to, carbon blacks, and transition metal oxides, such as, titanium dioxide and iron oxides, such as red iron oxide, black iron oxide, and yellow iron oxide. Examples of organic pigments include, but are not limited to: quinacridones; phthalocyanines, such as phthalo green and phthalo blue; naphthols, such as naphthol red; and anthracenes, such as anthracene-9,10-diones, including for example pigments derived from carminic acid, such as carmine.

With some embodiments, the colorant includes carmine. In accordance with some further embodiments, the colorant is carmine.

With some embodiments, the colorant is a food grade colorant, which has been approved by a government body, such as the US Food and Drug Administration for use in foods. Examples of food grade colorants include, but are not limited to, FD&C Blue No. 1, FD&C Blue No. 2, FD&C Green No. 3, FD&C Red No. 40, FD&C Red No. 3, FD&C Yellow No. 5, FD&C Yellow No. 6, and combinations of two or more thereof.

The colorant, with some embodiments, is present in any suitable amount that provides a desired color to the composition and tablet. The colorant is present, with some embodiments, for purposes of providing the composition and tablet with a color that allows it to be visually distinguishable from other compositions and tablets, such as other water treatment compositions and tablets, such as calcium hypochlorite compositions and calcium hypochlorite tablets, 1,3,5-trichloro-1,3,5-triazine-2,4,6-trione (also known as trichloro-s-triazinetrione) compositions and tablets, and bromochlorodimethylhydantoin compositions and tablets.

With some embodiments, the colorant is present in an amount of less than or equal to 10 percent by weight (or up to 10 percent by weight), or less than or equal to 5 percent by weight (or up to 5 percent by weight), or less than or equal to 1 percent by weight (or up to 1 percent by weight) based on the total weight of the composition. In accordance with some further embodiments, the colorant is present in an amount of 0.01 percent by weight to 10 percent by weight, or 0.01 percent by weight to 5 percent by weight, or 0.01 percent by weight to 1 percent by weight, or from 0.02 percent by weight to 0.5 percent by weight, or from 0.03 percent by weight to 0.3 percent by weight, based on the total weight of the composition. In accordance with some additional embodiments, the colorant is present in an amount less than or equal to 0.075 percent by weight (or up to 0.075 percent by weight) such as from 0.01 percent by weight to 0.075 percent by weight, based on the total weight of the composition.

In accordance with some embodiments, the compositions and tablets of the present invention are composed only of: (a) at least one alkali metal hydrogen sulfate anhydrous; and (b) at least one salt that is different than the alkali metal hydrogen sulfate anhydrous, in which the salt is selected from alkali metal salt, alkaline earth metal salt, and combinations thereof.

In accordance with some further embodiments, the compositions and tablets of the present invention are composed only of: (a) at least one alkali metal hydrogen sulfate anhydrous; (b) at least one salt that is different than the alkali metal hydrogen sulfate anhydrous, wherein the salt is selected from the group consisting of alkali metal salt, alkaline earth metal salt, and combinations thereof; and (c) a colorant.

The compositions of the present invention are, in accordance with some embodiments, free of one or more polysaccharide binders, one or more polyvinylpyrrolidone binders, one or more polyvinyl acetate binders, one or more polyalkylene glycol ether binders, and one or more alkaline earth metal carboxylate binders. Examples of polysaccharide binders include, but are not limited to, methyl cellulose binders, hydroxyl propyl cellulose binders, starch binders, sodium alginate binders, and xantham binders. Examples of polyalkylene glycol ether binders include, but are not limited to, polyethylene glycol ether binders, polypropylene glycol ether binders, and poly(ethylene glycol ether propylene glycol ether) binders. Examples of alkaline earth metal carboxylate binders include, but are not limited to, alkaline earth metal salts of fatty carboxylic acids, such as calcium stearate and magnesium stearate.

By free of one or more polysaccharide binders, one or more polyvinylpyrrolidone binders, one or more polyvinyl acetate binders, one or more polyalkylene glycol ether binders, and one or more alkaline earth metal carboxylate binders, means, with some embodiments, that the compositions of the present invention contain less than 0.1 percent by weight, or less then 0.05 percent by weight, or less than 0.01 percent by weight, or 0 percent by weight of one or more such materials, based on total weight of the composition.

In accordance with the present invention there is also provided a method of forming a treated aqueous stream, which involves contacting a feed aqueous stream with the composition of the present invention, as described previously herein. The treated aqueous stream can be formed as a batch process or as a continuous process.

The feed aqueous stream includes, with some embodiments, water. With some embodiments, the feed aqueous stream is drawn from an untreated fresh water source, such as untreated well water, untreated river water, untreated lake water, untreated cistern water, and combinations thereof. The feed aqueous stream, with some further embodiments, is drawn from a treated, such as sanitized, fresh water source, such as treated well water, treated river water, treated lake water, treated cistern water, and city water.

In accordance with some embodiments of the method of the present invention, the treated aqueous stream has a pH that is lower than (or less than) the pH of the feed aqueous stream. In accordance with some further embodiments, the treated aqueous stream has a pH of less than or equal to 8, such as less than or equal to 7.5, such as less than or equal to 7, or from 1 to 8, or from 1 to 7.5, or from 2 to 7, or from 3 to 6.5, or from 4 to 6. With some embodiments, the treated aqueous stream has a pH of from 6 to 8, or from 6 to 7.5, or from 6 to 7.

The feed aqueous stream can be contacted with the composition of the present invention in any suitable manner. With some embodiments, the composition of the present invention is contained in a container and the feed aqueous stream is introduced into the container. The introduced feed aqueous stream is, with some batch embodiments, held in the container for a period of time, and then at least a portion thereof removed from the container as the treated aqueous stream. The feed aqueous stream is, with some continuous embodiments, introduced continuously into the container, and the treated aqueous stream is removed continuously from the container.

For purposes of non-limiting illustration and with reference to FIG. 1, the water treatment system 3 includes a first feeder unit 11 that contains the tablets of the present invention (not visible in FIG. 1). A feed aqueous stream is introduced into the first feeder unit 11 as indicated by arrow 14, which also represents a conduit 14. The feed aqueous stream and the tablets of the present invention are contacted together within first feeder unit 11. A treated aqueous stream is withdrawn from first feeder unit 11 as indicated by arrow 17, which also represents a conduit 17. The pH of the treated aqueous stream passing through conduit 17 is measured by a suitable probe, such as probe 20. The pH output signals of probe 20 are relayed to a processor unit 26 by electrical connection 23. Processor unit 26 can be connected to an external power source, not shown, by electrical connection 29. Depending on the pH values transmitted to processor unit 26, the amount and rate of feed aqueous stream introduced into first feeder unit 11 and/or the amount and rate of treated aqueous stream removed from first feed unit 11 can be adjusted by one or more valves, such as remotely controlled valves, not shown. The treated aqueous stream passing through conduit 17 can be used for any suitable purpose, such as but not limited to: application to a surface, such as equipment surfaces and/or food surfaces, for purposes of cleaning the surface; and/or combination with another aqueous stream for purposes adjusting the pH of the other aqueous stream.

In accordance with the present invention there is further provided a method of forming a treated sanitizing aqueous stream, that involves forming a first treated aqueous stream, such as the treated aqueous stream as described above, and combining at least a portion of the first treated aqueous stream with a feed sanitizing stream that includes free available halogen, thereby forming the treated sanitizing aqueous stream that includes free available halogen.

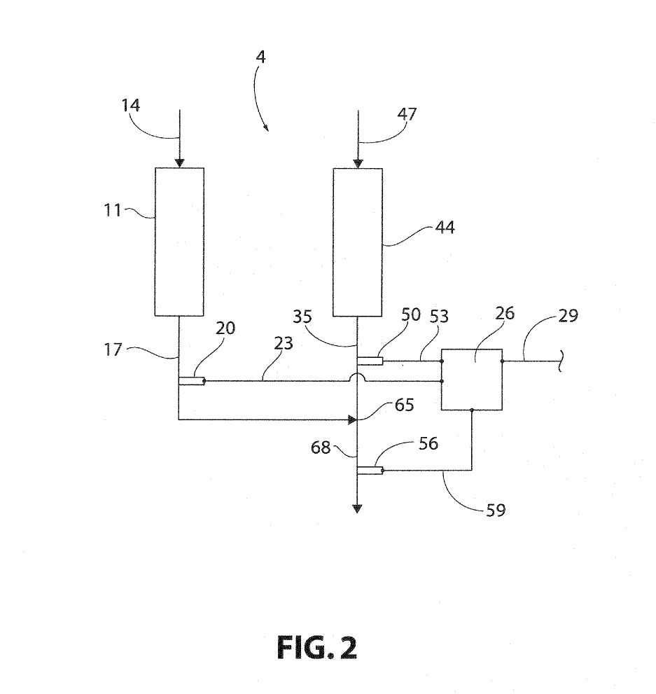

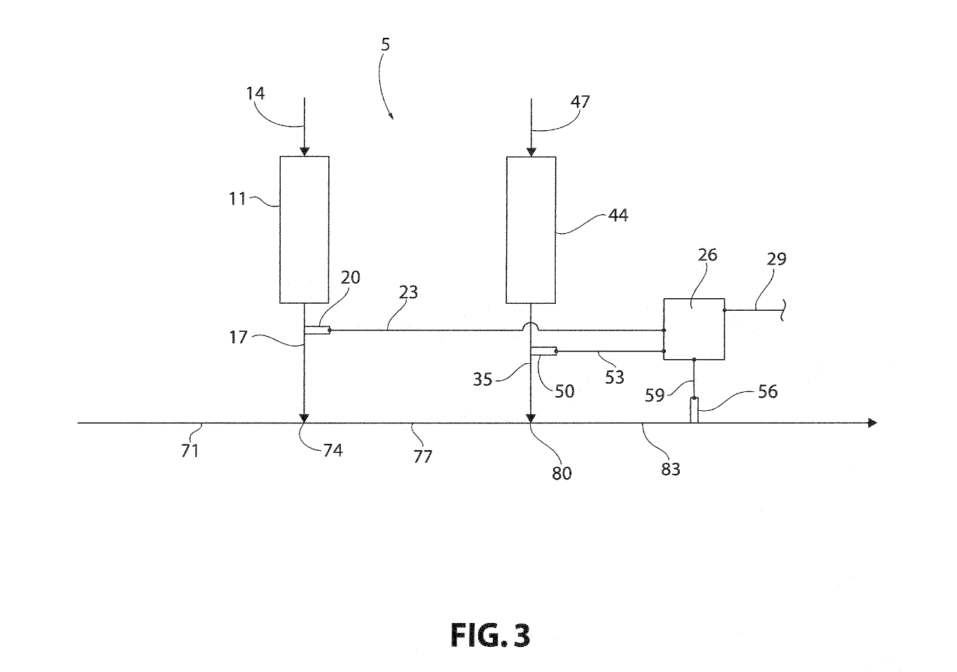

The first treated aqueous stream and the feed sanitizing stream can be combined by any suitable method or methods. With some embodiments, the first treated aqueous stream and the feed sanitizing stream are combined together in a mixing tank, such as in accordance with the non-limiting embodiments as described further herein with reference to FIG. 1. The first treated aqueous stream and the feed sanitizing stream are combined together, with some embodiments, by introducing the first treated aqueous stream into a conduit carrying the feed sanitizing aqueous stream, such as in accordance with the non-limiting embodiments as described further herein with reference to FIG. 2. The first treated aqueous stream and the feed sanitizing aqueous stream are combined together, with some further embodiments, by introducing the feed sanitizing aqueous stream into a conduit carrying the first treated aqueous stream, not depicted in the drawings. The first treated aqueous stream and the feed sanitizing stream are combined together, with some additional embodiments, by introducing the first treated aqueous stream and the feed sanitizing aqueous stream into a conduit carrying a primary aqueous stream, such as in accordance with the non-limiting embodiments as described further herein with reference to FIG. 3.

The term “free available halogen” as used herein means halogen that is present in an oxidized form in an aqueous solution, such as the feed sanitizing stream and the treated sanitizing aqueous stream. Free available halogen (FAH) is present in the form of hypohalous acid (HOX) and/or hypohalite anion (XO⁻), wherein X represents a halogen group having a +1 oxidation state. The halogen, X, of the free available halogen is selected from chlorine, bromine and iodine, with some embodiments.

The free available halogen of the feed sanitizing aqueous stream and the treated sanitizing aqueous stream, with some embodiments, includes free available chlorine, free available bromine, or free available iodine. With some embodiments, the free available halogen of the feed sanitizing aqueous stream and the treated sanitizing aqueous stream includes, or is, free available chlorine.

The amount of free available halogen present in the feed sanitizing aqueous stream and the treated sanitizing aqueous stream can vary, provided that, with some embodiments, the treated sanitizing aqueous stream includes at least a sufficient amount of free available halogen such that it can be used to clean and/or sanitize one or more surfaces to which it is applied. With some embodiments, the amount of free available halogen in the treated sanitizing aqueous stream is less than the amount of free available halogen present in the feed sanitizing aqueous stream, because the treated aqueous stream is combined with the feed sanitizing aqueous stream, thereby resulting in a reduced or diluted amount of free available halogen within the resulting treated sanitizing aqueous stream.

With some embodiments, the amount of free available halogen present in the treated sanitizing aqueous stream is from 0.001 percent to 99.9 percent less than, or from 10 percent to 90 percent less than, or from 25 percent to 75 percent less than the amount of free available halogen present in the feed sanitizing aqueous stream.

The amount of free available halogen present in the treated sanitizing aqueous stream and the amount of free available halogen present in the feed sanitizing aqueous stream are, with some embodiments, each independently from 10 ppm to 100,000 ppm, or from 30 ppm to 30,000 ppm, or from 50 to 20,000 ppm, or from 50 ppm to 5000 ppm, or from 50 ppm to 1000 ppm, or from 50 to 500 ppm provided that, with some further embodiments, the amount of free available halogen present in the treated sanitizing aqueous stream is lower than the amount of free available halogen present in the feed sanitizing aqueous stream. With some further embodiments, the amount of free available halogen present in the treated sanitizing aqueous stream is at least 1 ppm, such as from 1 ppm to 1000 ppm, or from 1 ppm to 500 ppm, or from 30 ppm to 50 ppm.

The free available halogen of the treated sanitizing aqueous stream includes, with some embodiments, free available chlorine, and the treated sanitizing aqueous stream has a pH of 6 to 8, or 6 to 7.5, or 6 to 7.

The feed sanitizing aqueous stream, in accordance with some embodiments, is formed by contacting a second feed aqueous stream with a source of free available halogen. The source of free available halogen releases free available halogen into the second feed aqueous stream, thereby resulting in formation of the feed sanitizing aqueous stream.

The source of free available halogen, with some embodiments, is selected from calcium hypochlorite, sodium hypochlorite, potassium hypochlorite, lithium hypochlorite, chlorine gas, 1,3,5-trichloro-1,3,5-triazine-2,4,6-trione, 1-bromo-3-chloro-5,5-dimethylhydantoin, and combinations thereof.

The first and second feed aqueous streams each independently include water, with some embodiments. With some further embodiments, the first and second feed aqueous streams are each independently drawn from an untreated fresh water source, such as untreated well water, untreated river water, untreated lake water, untreated cistern water, and combinations thereof. The first and second feed aqueous streams, with some additional embodiments, are each independently drawn from a treated, such as sanitized, fresh water source, such as treated well water, treated river water, treated lake water, treated cistern water, and city water. The first and second feed aqueous streams are, with some embodiments, drawn from the same or different sources. The first and second feed aqueous streams are the same or different, with some embodiments.

In accordance with some embodiments of the present invention, for purposes of non-limiting illustration, and with reference to the water treatment system 3 of FIG. 1, one or more tablets according to the present invention are contained within first feeder unit 11. A first feed aqueous stream is introduced into first feeder unit 11 as indicated by arrow 14, which also represents a conduit 14. The first feed aqueous stream and the tablet(s) according to the present invention are contacted with each other within first feeder unit 11. A first treated aqueous stream is formed in and withdrawn from first feeder unit 11 as indicated by arrow 17, which also represents a conduit 17.

The first treated aqueous stream is forwarded through conduit 17 and into mixing tank 32 where it is combined with a feed sanitizing aqueous stream that has been forwarded through conduit 35 into mixing tank 32. Mixing tank 32 can include one or more dynamic mixers, such as one or more impellers, not shown. A treated sanitizing aqueous stream 38 is accordingly formed within mixing tank 32. The treated sanitizing aqueous stream 38 is removed and forwarded from mixing tank 32 through conduit 41. The treated sanitizing aqueous stream 38 can be held within mixing tank 32 and intermittently released from mixing tank 38 through conduit 41. Alternatively, the treated sanitizing aqueous stream 38 can be continuously removed from mixing tank 32 and continuously forwarded through conduit 41 as the sanitizing aqueous stream 38 is formed within mixing tank 32.

With further reference to FIG. 1, the feed sanitizing aqueous stream is formed within second feeder unit 44. Second feeder unit 44 includes a source of free available halogen, such as calcium hypochlorite, which can be in form of one or more calcium hypochlorite tablets. A second feed aqueous stream is introduced into second feeder unit 44 as indicated by arrow 47, which also represents a conduit 47. The second feed aqueous stream contacts the source of free available halogen within second feeder unit 44, which results in formation of the feed sanitizing aqueous stream that is removed from second feeder unit 44 and forwarded to mixing tank 32 through conduit 35.

The pH of the first treated aqueous stream can be measured as it passes through conduit 17 by probe 20 as described previously herein with regard to the treated aqueous stream. The pH and/or conductivity of the feed sanitizing aqueous stream passing through conduit 35 can be measured by probe 50. The pH and/or conductivity data measured by probe 50 are forwarded to processor unit 26 by electrical connection 53. Depending on the pH and/or conductivity values transmitted to processor unit 26 through electrical connection 53, the amount and rate of the second feed aqueous stream introduced into second feeder unit 44 through conduit 47 and/or the amount and rate of the feed sanitizing aqueous stream removed from second feed unit 44 through conduit 35 can be adjusted by one or more valves, such as remotely controlled valves, not shown.

The pH of the treated sanitizing aqueous stream 38 formed within mixing tank 32 can be measured by probe 56. Alternatively, or additionally, probe 56 can be placed in contact with conduit 41 so as to measure the pH of the treated sanitizing aqueous stream passing therethrough (not depicted in FIG. 1). The pH values measured by probe 56 are transmitted to processor unit 26 by electrical connection 59. Depending on the pH values transmitted to processor unit 26 through electrical connection 59, the amount and rate of the treated aqueous stream introduced into mixing tank 32 through conduit 17 and/or the amount and rate of the feed sanitizing aqueous stream introduced into mixing tank 32 through conduit 35 can be adjusted by one or more valves, such as remotely controlled valves, not shown.

With some embodiments, the level 62 of treated sanitizing aqueous stream 38 within mixing tank 32 can be measured by one or more probes (not shown) and transmitted to processor unit 26. The level 62 can be adjusted by adjusting the amount and rate of the treated aqueous stream introduced into mixing tank 32 through conduit 17, and/or adjusting the amount and rate of the feed sanitizing aqueous stream introduced into mixing tank 32 through conduit 35, and/or adjusting the amount and rate of treated sanitizing aqueous stream removed from mixing tank 32 through conduit 41 by one or more valves, such as remotely controlled valves, not shown.

In accordance with some embodiments, a third feed aqueous stream can be introduced and mixed or combined with the treated aqueous stream and the feed sanitizing aqueous stream. The third feed aqueous stream can be introduced for purposes including, but not limited to, adjusting the concentration of free available halogen present in the resulting treated sanitizing aqueous stream (such as by dilution). The third feed aqueous stream can be selected from one or more of those sources as described previously herein with regard to the first and second feed aqueous streams, such as city water.

For purposes of non-limiting illustration, attention is directed to treatment system 3 of FIG. 1, in which a third feed aqueous stream is introduced into mixing tank 32 as indicated by arrow 86, which also represents a conduit 86, with some embodiments of the present invention. The rate and flow of the third feed aqueous stream introduced into mixing tank 32 can be controlled by one or more valves (not shown), which may be controlled by processor unit 26 in response to signals transmitted thereto by one or more probes in probing contact with conduit 86 (not shown).

The method of forming a treated sanitizing aqueous stream with some embodiments of the present invention can be performed with the water treatment system 4 of FIG. 2. For purposes of non-limiting illustration and with reference to FIG. 2, a first treated aqueous stream is formed in first feeder unit 11 and forwarded through conduit 17 as described previously herein. A feed sanitizing aqueous stream is formed in second feeder unit 44 and forwarded through conduit 35 as described previously herein. Conduit 17 is in fluid communication with conduit 35 at intersection point 65. At intersection point 65 the first treated aqueous stream forwarded through conduit 17 is combined with the feed sanitizing aqueous stream forwarded through conduit 35, which results in the formation of a treated sanitizing aqueous stream that is forwarded from intersection point 65 through conduit 68.

The pH of the treated sanitizing aqueous stream forwarded through conduit 68 is measured by probe 56 in accordance with the description provided previously herein with regard to measurement of the pH of the treated sanitizing aqueous stream within mixing tank 32 of water treatment system 3 of FIG. 1.

In accordance with some embodiments of the present invention, the method of forming a treated sanitizing aqueous stream includes: providing a primary aqueous stream; forming a first treated aqueous stream, as described previously herein; combining the first treated aqueous stream with the primary aqueous stream; and combining a feed sanitizing aqueous stream with the primary aqueous stream, upstream and/or downstream of where the first treated aqueous stream is combined with the primary aqueous stream, thereby forming the treated sanitizing aqueous stream. With some further embodiments, the first treated aqueous stream is combined with the primary aqueous stream upstream and/or downstream of where the feed sanitizing aqueous stream is combined with the primary aqueous stream. The feed sanitizing aqueous stream can be formed, with some embodiments, in accordance with the description provided previously herein.

With some embodiments, the method of forming a treated sanitizing aqueous stream includes: providing a primary aqueous stream; forming a first treated aqueous stream, as described previously herein; combining the first treated aqueous stream with the primary aqueous stream, thereby forming an intermediate primary aqueous stream; and combining a feed sanitizing aqueous stream with the intermediate primary aqueous stream, downstream of where the first treated aqueous stream is combined with the primary aqueous stream, thereby forming the treated sanitizing aqueous stream.

With some further embodiments, the method of forming a treated sanitizing aqueous stream includes: providing a primary aqueous stream; combining a feed sanitizing aqueous stream with the primary aqueous stream, thereby forming an intermediate primary aqueous stream; forming a first treated aqueous stream, as described previously herein; and combining the first treated aqueous stream with the intermediate primary aqueous stream, downstream of where the feed sanitizing aqueous stream is combined with the primary aqueous stream, thereby forming the treated sanitizing aqueous stream.

The primary aqueous stream can, with some embodiments, be selected from those sources as described previously herein with regard to the first and second feed aqueous streams, such as (but not limited to) city water.

For purposes of non-limiting illustration and with reference to the water treatment system 5 of FIG. 3, a primary aqueous stream is provided from a source (not shown) and forwarded through conduit 71 (or conduit segment 71). A treated aqueous stream is formed in feeder unit 11, as described previously herein, and combined with the primary aqueous stream at intersection point or junction 74 with conduit 71. The primary aqueous stream with the treated aqueous stream combined therewith (which can be referred to as an intermediate primary aqueous stream with some embodiments) is forwarded through conduit 77 (or conduit segment 77).

With further reference to FIG. 3, a feed sanitizing aqueous stream is formed in feeder unit 44 and forwarded through conduit 35 as described previously herein. The feed sanitizing aqueous stream is combined with the intermediate primary aqueous stream at intersection point or junction 80 with conduit (or conduit portion) 77, which results in the formation of a treated sanitizing aqueous stream that is forwarded through conduit (or conduit portion) 83. Intersection point 80 is downstream of intersection point 74, and intersection point 74 is upstream of intersection point 80.

The pH of the first aqueous feed stream forwarded through conduit 17, and the pH and/or conductivity of the feed sanitizing aqueous stream forwarded through conduit 35 can be measured by probes 20 and 50 and transmitted to process controller 26 by electrical connections 23 and 53 as described previously herein with regard to water treatment systems 3 and 4. The pH and/or conductivity of the treated sanitizing aqueous stream forwarded through conduit 83 can be measured with one or more probes, such as represented by probe 56, that are in probing contact with conduit 83, which can relay measurement data to processor controller 26 by electrical connection 59, as described previously herein. The amount and rate of, the primary aqueous stream flowing through conduit 71, the treated aqueous stream flowing through conduit 17, the feed sanitizing aqueous stream flowing through conduit 35, and the treated sanitizing aqueous stream flowing through conduit 83 can each be independently controlled by processor unit 26 by one or more valves (not shown).

With some further alternative embodiments, conduit 35 is in fluid communication with intersection point 74, and conduit 17 is in fluid communication with intersection point 80 (not depicted in FIG. 3), in which case the feed sanitizing aqueous stream is combined with the primary aqueous stream at intersection point 74, which results in the formation of an intermediate primary aqueous stream, which is forwarded through conduit 77. Correspondingly, downstream of where the feed sanitizing aqueous stream is combined with the primary aqueous stream (at intersection point 74), the first treated aqueous stream is combined with the intermediate primary aqueous stream at intersection point 80, which results in formation of the treated sanitizing aqueous stream, which is forwarded through conduit 83.

In accordance with the present invention there is additionally provided a method of treating a surface, such as cleaning and/or sanitizing a surface, that includes forming a treated sanitizing aqueous stream as described previously herein, and then applying the treated sanitizing aqueous stream to a surface to be treated, such as to be cleaned and/or sanitized. The treated sanitizing aqueous stream can be applied by any appropriate method, examples of which include but are not limited to: spray application; wiping with soaked rags; curtain or waterfall application; and soaking by immersion.

The surface, with some embodiments, to be sanitized, by application of the treated sanitizing aqueous stream thereto, is selected from vegetable surfaces, fruit surfaces, equipment surfaces, animal carcass surfaces, and combinations thereof, with some embodiments. Additional surfaces that can be sanitized in accordance with the method of the present invention include, but are not limited to: harvested vegetables, such as potatoes, sweet potatoes, tomatoes, rutabagas, beets, and mushrooms; harvested fruits, such as apples, oranges, plums, pears, and mangos; metal surfaces in food processing plants, such as meat procession plants; equipment in breweries, such as fermenting tubs, mash tuns, pipe interiors, and pipe exteriors; fowl carcasses in fowl processing plants, such as chicken carcasses in chicken processing plants, and turkey carcasses in turkey processing plants; beef carcasses in beef processing plants; and pork carcasses in pork processing plants.

The present invention is more particularly described in the examples that follow, which are intended to be illustrative only, since numerous modifications and variations therein will be apparent to those skilled in the art.

### Examples

### Tablet Compositions and Tablet Preparation

Tablets having a weight of 30 grams, a diameter of 45 mm, and a thickness of 9 mm, were prepared from materials as summarized in the following Table 1 and in accordance with the description provided thereafter.

TABLE 1

| | Sodium bisulfate | Sodium | |
|---|---|---|---|
| Tablet | anhydrous^{(a)} | Chloride^{(b)} | Colorant^{(c)} |
| Composition | (% Wt.) | (% Wt.) | (% Wt.) |
| 1 | 85 | 15 | 0.0075 |
| 2 | 80 | 20 | 0 |
| 3 | 90 | 10 | 0.0075 |

^{(a)}The sodium bisulfate anhydrous was obtained from ACROS Organics, 92% technical grade, granular (lot A0326674).
^{(b)}The sodium chloride was obtained from Fisher Scientific, Certified A.C.S., catalog #S271 (lot #005697).
^{(c)}The colorant in Tablet Compositions 1 and 3 was Carmine colorant obtained from ACROS Organics, high purity, code 190200250 (lot A0285879).

Tablets were prepared from the tablet compositions summarized in Table 1 by placing relative amounts of the recited components in a 250 ml NALGENE container, which was then placed and packed sideways in a 2 liter NALGENE container. The packed 2 liter NALGENE container was then rolled for 20 minutes on a U.S. Stoneware roller (series number CV 89308), which resulted in the 250 ml NALGENE container being rolled end-over-end within the 2 liter NALGENE container. The blended material was removed from the 250 ml NALGENE container, and 30 grams thereof was placed in a CHEMPLEX annealed stainless steel die set (45 mm pellet die without side-arms), and pressed into a tablet using an automatic 30 ton force SPECTROPRESS apparatus obtained from CHEMPLEX Industries, Inc.

### Tablet Testing

The hardness and moisture absorption of the tablets corresponding to tablet compositions 1-3 were evaluated in accordance with the following descriptions. The results of the hardness and moisture absorption tests are summarized in Table 2 below.

Hardness was evaluated by dropping tablets from a height of 165.1 cm (65 inches) onto a flat smooth cement surface. After hitting the cement surface, the tablets were evaluated visually with regard to: the number of pieces they broke into; and the amount of dust produced, which was subjectively determined. Tablets that break into a minimal number of pieces and produce minimal or no dust are desirable.

Moisture absorption was evaluated by placing tablets in a sealed desiccator having water in the bottom thereof. The tablets resided in watch glasses supported above the water level. The tablets were determined to have failed the moisture test by visual observation when: (1) the tablet was observed to be too swollen to maintain its original form; or (2) the tablet was observed to be excessively wet or formed a solution. When the tablets were determined to have failed, the time to failure was noted, and they were removed from the desiccator and weighed. The tablet weight at the time of moisture failure and the original tablet weight (determined prior to moisture testing) of the tablets were used to calculate the percent weight of moisture absorption. Tablets that have a greater moisture failure time (i.e., time until moisture failure was observed) and lower percent weight moisture absorption are desirable. Tablets that provide a desirable combination (or balance) of hardness and resistance to moisture absorption are more desirable.

TABLE 2

| | | Moisture | | |
|---|---|---|---|---|
| | | Failure | Moisture | |
| Tablet | | Time | Absorption | |
| Composition | Hardness^{(d)} | (hours) | (Wt. %) | Observations^{(e)} |
| 1 | 5Δ | 45 | 7.33 | Failed the |
| | | | | hardness test. |
| 2 | 2◯ | 72 | 15.97 | Wet at base, |
| | | | | dissolving |
| | | | | and forming |
| | | | | solution. |
| 3 | 4□ | 231 | 9.98 | Edges of tablet |
| | | | | broke off, |
| | | | | flaking and |
| | | | | swelling of |
| | | | | outer edge. |

^{(d)}With the hardness results, the numbers (5, 2, and 4) refer to the number of broken pieces of the tablet that were observed after being dropped onto concrete. The symbols following the number are described as follows:
◯ - No dust produced.
□ - Minimal dust produced.
Δ - Visible dust produced, but not a considerable amount.
^{(e)}The observations relate to the hardness test for Tablet 1, and the condition of Tablets 2 and 3 after failure of the moisture test was determined to have occurred.

Tablets prepared from Tablet Composition 3 were determined to have a desirable balance of both hardness and resistance to moisture absorption, which indicates they possess a desirable level of shelf life.

The present invention has been described with reference to specific details of particular embodiments thereof. It is not intended that such details be regarded as limitations upon the scope of the invention except insofar as and to the extent that they are included in the accompanying claims.

What is claimed is:

1. A composition comprising:
(a) at least one alkali metal hydrogen sulfate anhydrous; and
(b) at least one salt that is different than said alkali metal hydrogen sulfate anhydrous, wherein said salt is selected from the group consisting of alkali metal salt, alkaline earth metal salt, and combinations thereof,
wherein said composition is in the form of a tablet.

2. The composition of claim 1 wherein said alkali metal hydrogen sulfate anhydrous (a) is present in an amount of from about 50 percent by weight to about 99 percent by weight, the percent weights being based on total weight of said composition.

3. The composition of claim 1 wherein said salt (b) is present in an amount of from about 1 percent by weight to about 50 percent by weight, the percent weights being based on total weight of said composition.

4. The composition of claim 1 wherein,
the alkali metal salt of said salt (b) is selected from the group consisting of one or more alkali metal halides, one or more alkali metal sulfates, and combinations thereof, and
the alkaline earth metal salt of said salt (b) is selected from the group consisting of one or more alkaline earth metal sulfates.

5. The composition of claim 4 wherein said salt (b) is selected from the group consisting of one or more alkali metal halides.

6. The composition of claim 5 wherein the alkali metal of each alkali metal halide is independently selected from the group consisting of sodium and potassium, and the halide of each alkali metal halide is independently selected from fluoride, chloride, bromide, and iodide.

7. The composition of claim 1 wherein said salt (b) is free of halide.

8. The composition of claim 1 wherein the alkali metal of said alkali metal hydrogen sulfate (a) is selected from the group consisting of sodium and potassium.

9. The composition of claim 1 wherein,
said alkali metal hydrogen sulfate anhydrous (a) is sodium hydrogen sulfate anhydrous, and
said salt (b) is sodium chloride.

10. The composition of claim 1 wherein said alkali metal hydrogen sulfate anhydrous contains water in an amount of about 0 percent by weight to about 1 percent by weight, the percent weights being based on the weight of said alkali metal hydrogen sulfate anhydrous.

11. The composition of claim 1 further comprising a colorant selected from the group consisting of dyes, pigments, and combinations thereof.

12. The composition of claim 11 wherein said colorant is a food grade colorant and is present in an amount of less than or equal to 1 percent by weight, based on the total weight of the composition.

13. The composition of claim 11 wherein said colorant comprises carmine.

14. The composition of claim 1 wherein said tablet has a density of about 1.8 g/cm³ to about 2.2 g/cm³.

15. The composition of claim 1 wherein said composition is free of one or more polysaccharide binders, one or more polyvinylpyrrolidone binders, one or more polyvinyl acetate binders, one or more polyalkylene glycol ether binders, and one or more alkaline earth metal carboxylate binders.

16. A method of forming a treated aqueous stream comprising:
(a) providing a composition comprising,
(i) at least one alkali metal hydrogen sulfate anhydrous, and
(ii) at least one salt that is different than said alkali metal hydrogen sulfate anhydrous, wherein said salt is selected from the group consisting of alkali metal salt, alkaline earth metal salt, and combinations thereof,
wherein said composition is in the form of a tablet; and
(b) contacting a feed aqueous stream with said composition, thereby forming said treated aqueous stream.

17. The method of claim 16 wherein said treated aqueous stream has a pH that is lower than a pH of the feed aqueous stream.

18. The method of claim 17 wherein said pH of said treated aqueous stream is less than or equal to 8.

19. The method of claim 16 wherein,
said alkali metal hydrogen sulfate anhydrous (a) is sodium hydrogen sulfate anhydrous, and
said salt (b) is sodium chloride.

20. A treated aqueous stream prepared according to the method of claim 16.

21. A method of forming a treated sanitizing aqueous stream comprising:
(a) providing a composition comprising,
(i) at least one alkali metal hydrogen sulfate anhydrous, and
(ii) at least one salt that is different than said alkali metal hydrogen sulfate anhydrous, wherein said salt is selected from the group consisting of alkali metal salt, alkaline earth metal salt, and combinations thereof,
wherein said composition is in the form of a tablet;
(b) contacting a first feed aqueous stream with said composition, thereby forming a first treated aqueous stream; and
(c) combining at least a portion of said first treated aqueous stream with a feed sanitizing aqueous stream comprising free available halogen, thereby forming said treated sanitizing aqueous stream comprising free available halogen.

22. The method of claim 21 wherein said treated sanitizing aqueous stream comprises free available chlorine.

23. The method of claim 22 wherein said treated sanitizing aqueous stream has a pH of about 6 to about 8.

24. The method of claim 21 wherein said feed sanitizing stream is formed by contacting a second feed aqueous stream with a source of free available halogen.

25. The method of claim 24 wherein said source of free available halogen is selected from the group consisting of calcium hypochlorite, sodium hypochlorite, potassium hypochlorite, lithium hypochlorite, chlorine gas, 1,3,5-trichloro-1,3,5-triazine-2,4,6-trione, 1-bromo-3-chloro-5,5-dimethylhydantoin and combinations thereof.

26. A method of sanitizing a surface comprising:
(a) providing a composition comprising,
(i) at least one alkali metal hydrogen sulfate anhydrous, and
(ii) at least one salt that is different than said alkali metal hydrogen sulfate anhydrous, wherein said salt is selected from the group consisting of alkali metal salt, alkaline earth metal salt, and combinations thereof,
wherein said composition is in the form of a tablet;
(b) contacting a first feed aqueous stream with said composition, thereby forming a first treated aqueous stream;
(c) combining at least a portion of said first treated aqueous stream with a feed sanitizing aqueous stream comprising free available halogen, thereby forming a treated sanitizing aqueous stream comprising free available halogen; and
(d) applying said treated sanitizing aqueous stream to a surface to be sanitized.

27. The method of claim 26 wherein said surface to be sanitized is selected from the group consisting of vegetable surfaces, fruit surfaces, equipment surfaces, animal carcass surfaces, and combinations thereof.
